(19) United States
(12) Patent Application Publication
(10) Pub. No.: US 2014/0090808 A1
(43) Pub. Date: Apr. 3, 2014

(54) HEAT-TRANSFER DEVICE

(71) Applicants: Hisanori Bessho, Osaka-shi (JP); Tetsuya Ide, Osaka-shi (JP); Shigeru Aomori, Osaka-shi (JP); Yuka Utsumi, Osaka-shi (JP); Yasuyuki Umenaka, Osaka-shi (JP); Takashi Yamashita, Osaka-shi (JP)

(72) Inventors: Hisanori Bessho, Osaka-shi (JP); Tetsuya Ide, Osaka-shi (JP); Shigeru Aomori, Osaka-shi (JP); Yuka Utsumi, Osaka-shi (JP); Yasuyuki Umenaka, Osaka-shi (JP); Takashi Yamashita, Osaka-shi (JP)

(73) Assignee: SHARP KABUSHIKI KAISHA, Osaka-shi, Osaka (JP)

(21) Appl. No.: 14/117,926

(22) PCT Filed: May 10, 2012
(86) PCT No.: PCT/JP2012/062017

§ 371 Date: Dec. 13, 2013

(30) Foreign Application Priority Data
May 17, 2011 (JP) 2011-110444

(51) Int. Cl. C09K 5/06; F28D 20/02

(52) U.S. Cl. CPC C09K 5/06; F28D 20/025
USPC 165/104.17

(57) ABSTRACT

The present invention relates to a heat-transfer device and has an object to provide a heat-transfer device that has a high degree of freedom of aspects in arrangement with respect to the heating element. The heat-transfer device is provided with a contact surface 20e coming into contact with a heating element 100. The heat-transfer device has a pin portion 20 transferring heat from the heating element 100 through the contact surface 20e, and has a gelled latent heat storage material 70 arranged to be in contact with the pin portion 20.

### TECHNICAL FIELD

The present invention relates to a heat-transfer device, particularly to a heat-transfer device that carries out heat-transfer by being in contact with a heating element.

### BACKGROUND ART

In the related art, a heat sink is a known heat-transfer device that transfers heat of a heating element by being in contact with the heating element. For example, PTL 1 discloses a heat sink in which “a plurality of latent heat storage materials which have different fusion points from each other and a liquid in which a heat-conductive fine powder filler is dispersed fill a space of a heat sink main body having high heat conductivity, and the latent heat storage materials are fused sequentially from a latent heat storage material that melts at a low temperature and liquefied to cause heat of the heating element to be convected and to be transferred to another latent heat storage material having a high fusion point to store much more heat by the fusion at a low temperature. Meanwhile, the heat is subject to the prompt heat-transfer from the heat-conductive fine powder filler that flows together with the liquid to a high heat-conductive heat sink container and is subject to outward radiation rapidly while having a low temperature. An effect of the latent heat storage and vaporizing at the low temperature by a solvent having a low boiling point cause a large amount of the heat to be transferred rapidly, thereby suppressing a temperature rise in the vicinity of the heating element and enabling control within a predetermined range.”

In addition, PTL 2 discloses a cooling device in which “a through hole in a direct longitudinal direction is provided in a heat-transfer substrate which is integrally provided with radiator fins, a palette is provided under the hole through a net, and a heat storage material that absorbs the heat when overheated and is liquefied at a predetermined temperature is inserted into the through hole.”

In addition, PTL 3 discloses a battery cooling device for electric vehicles “having a configuration in which a heat pipe is brought into contact with one end of a battery module, the other end of which is connected to a heat sink; the heat generated by the battery is transported to the heat sink; a heat storage material such as paraffin is included inside the heat sink; there are provided a cooling water path passing through the inside of the heat storage material, a cooling water pipe connected to the cooling water path, an electric pump and a radiator; and the heat transferred to the heat sink is spent as latent heat of the heat storage material and enabled to be also radiated to the open air by the radiator through the cooling water.”

### CITATION LIST

### Patent Literature

PTL 1: Japanese Unexamined Patent Application Publication No. 2010-251677
PTL 2: Japanese Unexamined Patent Application Publication No. 4-101450
PTL 3: Japanese Unexamined Patent Application Publication No. 11-204151
PTL 4: Japanese Unexamined Patent Application Publication No. 2003-45630
PTL 5: Japanese Unexamined Patent Application Publication No. 2005-143265
PTL 6: Japanese Unexamined Patent Application Publication No. 2001-214851
PTL 7: Japanese Unexamined Patent Application Publication No. 10-99191

### SUMMARY OF INVENTION

### Technical Problem

In general, a heat sink and a cooling device carry out radiation using natural convection of air coming into contact with radiator fins which are provided in the device. Therefore, if a large amount of heat-transfer is carried out, there is a need for increasing the number of fins of the radiator fin, thereby causing the device to be increased in size. In addition, if the heat of the radiator fins is forcibly cooled by a cooling fan, there are needs for securing an installation space of the cooling fan and noise control, and there occurs a problem of an increase in electricity consumption.

In the heat sink described in PTL 1, a liquid in which a heat-conductive fine powder filler is dispersed needs to be convected, and a fused latent heat storage material further needs to be convected. The heat-transfer by convection is oriented vertically upwards, in general. Therefore, aside from a case where a heating element is positioned vertically below the heat sink, for example, if the heating element is positioned vertically above the heat sink, it is not possible to efficiently carry out the heat-transfer by convection. In general, it is not possible to fill a space inside the heat sink with the latent heat storage material having phase change between a liquid phase and a solid phase in a space inside the heat sink without a gap. Therefore, a gap is generated inside the space of the heat sink main body when the latent heat storage material is in a liquefied state. A shape of the gap changes in accordance with an installation angle of the heat sink or the like. Accordingly, the liquefied latent heat storage material inside the space of the heat sink main body also changes in shape, thereby causing fluctuation in efficiency of heat radiation and storage. In addition, since the latent heat storage material is hermetically sealed inside the heat sink, a heat stored by the latent heat storage material is radiated only through the heat sink so as to cause a problem in that effective utilization of the heat cannot be achieved.

In the cooling device described in PTL 2, there is a need for accumulating the heat storage material that absorbs the heat when liquefied by overheating in a palette therebelow once, and then, refilling a through hole with the heat storage material. Therefore, aspects in arrangement of the cooling device are limited with respect to the heating element, and handling of the cooling device is difficult, thereby being impractical to employ for cooling of the heating elements that are built in ordinary electrical appliances.

In the battery cooling device for electric vehicles described in PTL 3, a problem similar to that of the heat sink described in PTL 1 may occur.

An object of the present invention is to provide a heat-transfer device that has a high degree of freedom of aspects in arrangement with respect to the heating element.

In addition, an object of the invention is to provide a heat-transfer device in which thermal fluctuation of the heating element is smoothed and temperature fluctuation of the heating element is suppressed.

Moreover, an object of the invention is to provide a heat-transfer device in which the device can be reduced in size and secured with a sufficient installation space for a cooling fan if needed, there is no need for noise control, and an increase in electricity consumption can be suppressed.

### Solution to Problem

The above described objects are achieved through a heat-transfer device including a heat-transfer member that is provided with a contact surface which comes into contact with a heating element and transfers heat of the heating element through the contact surface, and a gelled latent heat storage material that is arranged to be in contact with the heat-transfer member and is also enabled to be in contact with the heating element.

The present invention provides the heat-transfer device in which the latent heat storage material includes a gelling agent.

The present invention provides the heat-transfer device in which the gelling agent includes a polymer material.

The present invention provides the heat-transfer device in which the latent heat storage material includes paraffin.

The present invention provides the heat-transfer device in which the latent heat storage material includes a hydrated salt based heat storage material.

The present invention provides the heat-transfer device in which the heat-transfer member is provided with a cavity portion therein.

The present invention provides the heat-transfer device in which the cavity portion is filled with the latent heat storage material.

The present invention provides the heat-transfer device in which the heat-transfer member is provided with an opening portion that is connected to the cavity portion.

The present invention provides the heat-transfer device in which the latent heat storage material is enabled to be in contact with the heating element in the opening portion.

The present invention provides the heat-transfer device in which the contact surface is formed around the opening portion.

The present invention provides the heat-transfer device in which the cavity portion has a larger cross-sectional area than that of the opening portion.

The present invention provides the heat-transfer device in which the cross-sectional area becomes larger as it is separated farther away from the opening portion.

The present invention provides the heat-transfer device in which the heat-transfer member is provided with a through hole through which the latent heat storage material is exposed, and the heat-transfer member has a heat conduction portion that transfers the heat outward by coming into contact with the latent heat storage material at the through hole.

The present invention provides the heat-transfer device in which the heat conduction portion is a heat pipe.

### Advantageous Effects of Invention

According to the present invention, it is possible to increase a degree of freedom of aspects in arrangement with respect to a heating element of a heat-transfer device.

In addition, according to the invention, it is possible to smooth thermal fluctuation of the heating element and suppress temperature fluctuation of the heating element.

Moreover, according to the invention, it is possible to reduce the device in size and secure a sufficient installation space for a cooling fan if needed, there is no need for noise control, and it is possible to suppress an increase in electricity consumption.

### BRIEF DESCRIPTION OF DRAWINGS

FIG. 1 is a view describing a shape of a 7 inch liquid crystal display module for a super bright backlight mounting type mobile which is used in a first embodiment of the present invention.

FIG. 2 is a view illustrating a result of temperature distribution measurement of a liquid crystal display module 2 in which each temperature of positions (1) to (11) is measured and plotted in an environment where the liquid crystal display module 2 that is used in the first embodiment of the invention is driven and an ambient temperature is changed in a range from 25° C. to 85° C.

FIG. 3 is a view illustrating an example of a pin-type heat sink that is installed in the liquid crystal display module 2 that is used in the first embodiment of the invention.

FIG. 4 is a view illustrating a result of the temperature distribution measurement of the liquid crystal display module 2 in which each temperature of the positions (1) to (11) is measured and plotted by driving the liquid crystal display module 2 to which a pin-type heat sink 10 that is used in the first embodiment of the invention is driven in the environment where the ambient temperature is changed in the range from 25° C. to 85° C.

FIG. 5 is a perspective view illustrating an outer shape of a portion of a heat-transfer device according to an Example 1 in the first embodiment of the invention.

FIG. 6 is a view illustrating a cross section of a pin portion 20 of the heat-transfer device according to the Example 1 in the first embodiment of the invention.

FIG. 7 is a view illustrating a cross section of a pin portion 200 according to a comparative example.

FIG. 8 is a view illustrating a result of a heat conduction analysis simulation for describing a difference in heat conductivity characteristic between the pin portion 20 according to the Example 1 in the first embodiment of the invention and the pin portion 200 according to the comparative example.

FIG. 9 is a view illustrating an effect of employing the pin portion 20 according to the Example 1 in the first embodiment of the invention.

FIG. 10 is a cross-sectional view illustrating a portion of the heat-transfer device according to an Example 2 in the first embodiment of the invention.

FIG. 11 is a cross-sectional view illustrating a portion of the heat-transfer device according to an Example 3 in the first embodiment of the invention.

FIG. 12 is a view illustrating a portion of the heat-transfer device according to a second embodiment of the invention.

### DESCRIPTION OF EMBODIMENTS

### First Embodiment

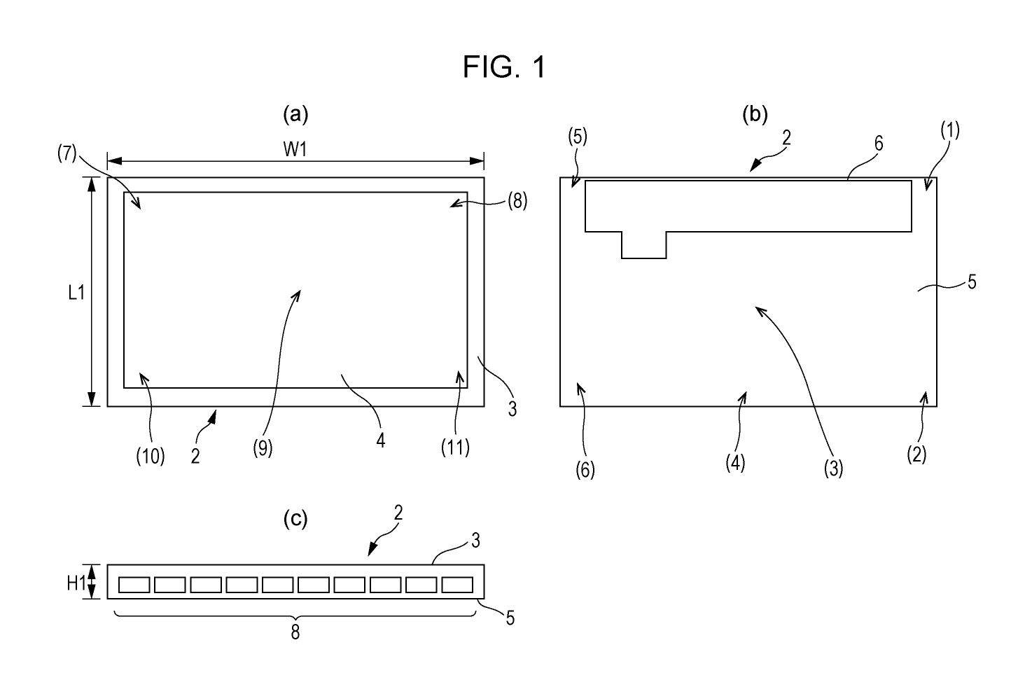

A heat-transfer device according to a first embodiment of the present invention will be described referring to FIGS. 1 to 11.

Firstly, a shape of a 7 inch liquid crystal display module for a super bright backlight mounting type mobile which is used in the embodiment will be described with reference to FIG. 1. FIG. 1(a) illustrates a front surface side of the liquid crystal display module. FIG. 1(b) illustrates a rear surface side of the liquid crystal display module. FIG. 1(c) illustrates a bottom surface side of the liquid crystal display module. As illustrated in FIG. 1(a), the front surface side of a liquid crystal display module 2 has a rectangular outer shape. The length L1 of each short side in the rectangular outer shape is 95 mm, and the length W1 of each long side is 180 mm. A frame-shaped bezel 3 is arranged around the liquid crystal display module 2. A rectangular opening region on the inner side of the bezel 3 is a display region. A panel display surface of a liquid crystal display panel 4 that is 7 inches long in the diagonal direction is arranged in the display region.

As illustrated in FIG. 1(b), a chassis 5 having the rectangular outer shape that substantially matches the outer shape of the bezel 3 is arranged on the rear surface side of the liquid crystal display module 2. The chassis 5 is manufactured of stainless steel, for example. A flexible printed circuit (FPC) 6 is arranged along an end side of an upper portion of the chassis 5. Between the bezel 3 and the chassis 5 of the liquid crystal display module 2, a super bright LED backlight 8 mounted with 35 side-view-LED lamps that are light sources of the liquid crystal display panel 4 is arranged immediately under the liquid crystal display panel 4. In addition, as illustrated in FIG. 1(c), the 35 LED lamps that are the light sources of the super bright LED backlight 8 are mounted in a parallel manner on a lower surface side (side surface that is the side opposite to the FPC 6 arrangement side) of the liquid crystal display module 2. A width H1 between the front surface side and the rear surface side of the liquid crystal display module 2 is 5 mm.

The positions indicated with reference numerals (1) to (11) in FIGS. 1(a) and 1(b) denote temperature measurement places in the liquid crystal display module 2. A temperature sensor (for example, thermocouple) is attached at the temperature measurement positions. The liquid crystal display module 2 is driven in an environment at a predetermined temperature, and each temperature at positions (1) to (11) is measured. The position (1) is in the vicinity of an upper right end portion of the chassis 5. The position (2) is in the vicinity of a lower right end portion of the chassis 5. The position (3) is in the vicinity of the center portion of the chassis 5. The position (4) is in the vicinity of a lower center portion of the chassis 5. The position (5) is in the vicinity of an upper left end portion of the chassis 5. The position (6) is in the vicinity of a lower left end portion of the chassis 5. The position (7) is in the vicinity of an upper left end portion of the display surface of the liquid crystal display panel 4. The position (8) is in the vicinity of an upper right end portion of the display surface of the liquid crystal display panel 4. The position (9) is in the vicinity of the center portion of the display surface of the liquid crystal display panel 4. The position (10) is in the vicinity of a lower left end portion of the display surface of the liquid crystal display panel 4. The position (11) is in the vicinity of a lower right end portion of the display surface of the liquid crystal display panel 4. The positions (2), (4) and (6) on the end side of the lower portion of the chassis 5 are positioned close to a mounting portion of the LEDs which is the light source of the super bright LED backlight 8.

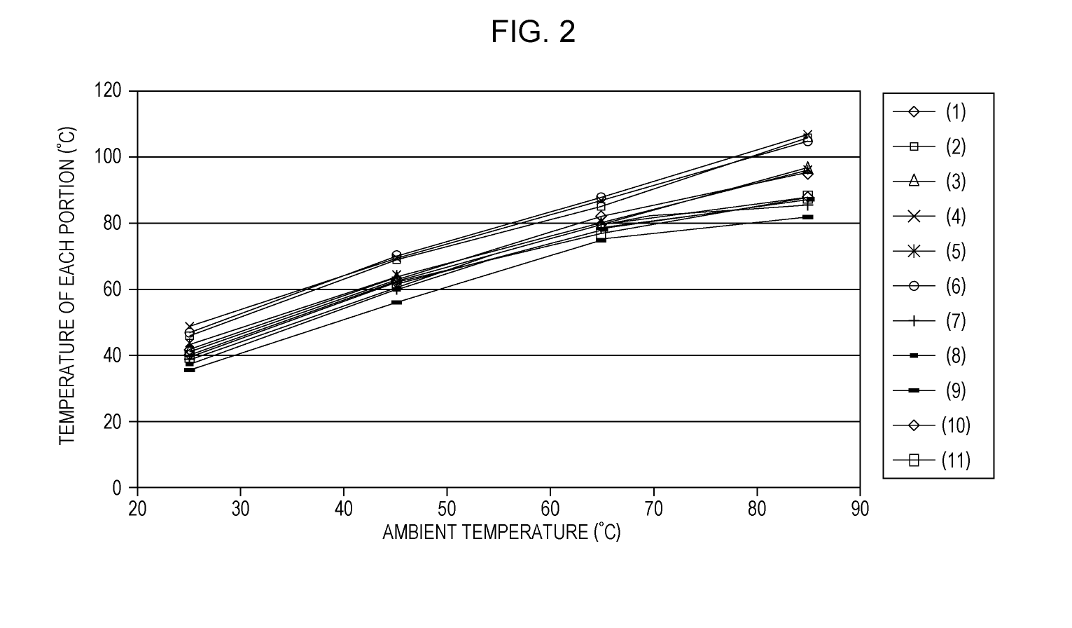

FIG. 2 illustrates a result of the temperature distribution measurement of the liquid crystal display module 2 in which each temperature of the positions (1) to (11) is measured and plotted by driving the liquid crystal display module 2 in the environment where the ambient temperature is changed in the range from 25° C. to 85° C. The horizontal axis in FIG. 2 shows the ambient temperature (° C.) of the liquid crystal display module 2, and the vertical axis shows the temperature (° C.) of each portion of the liquid crystal display module 2. Each temperature of the positions (1) to (11) is illustrated in data lines that respectively correspond to the illustrated symbols in explanatory notes at a right side of the view. As illustrated in FIG. 2, it is understood that all the positions (2), (4) and (6) exceed 100° C. when the ambient temperature is at 85° C. This shows that the temperature of the chassis 5 around the super bright LED backlight 8 exceeds 100° C. in the environment where the ambient temperature is at 85° C. Therefore, there is a possibility of the temperature of a light-guiding panel or a resin component that constitutes the backlight exceeding a guaranteed temperature, and there is a need to take sufficient countermeasures in order to secure reliability in the liquid crystal display module 2.

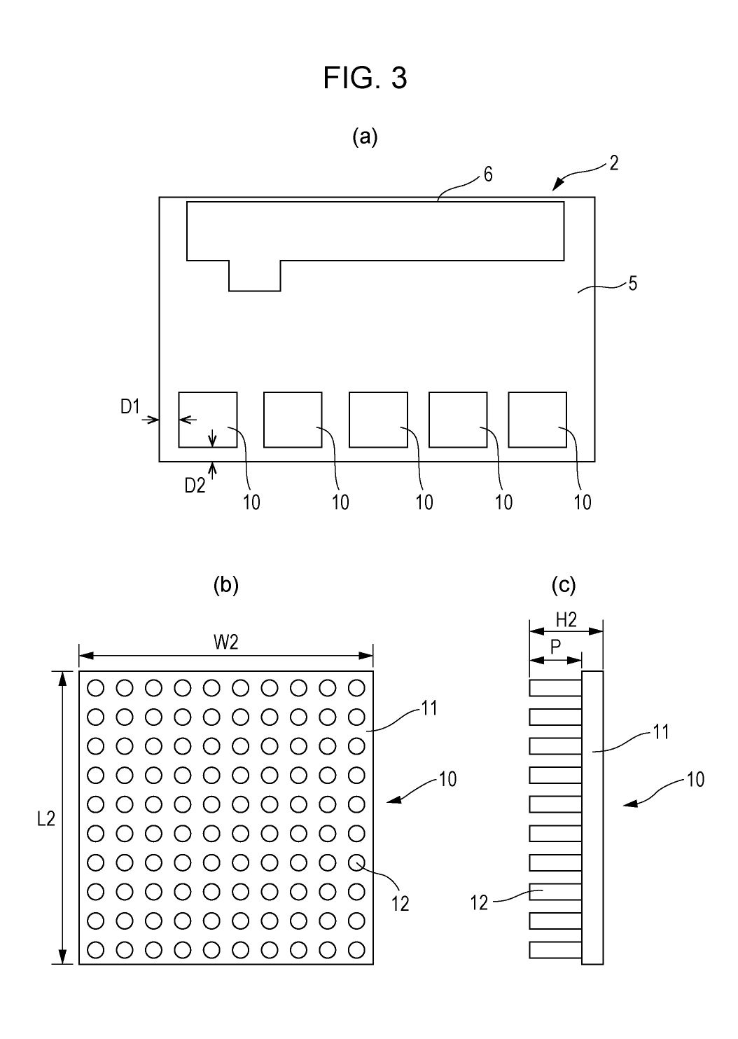

FIG. 3 illustrates an example of a pin-type heat sink that is installed in the liquid crystal display module 2. FIG. 3(a) illustrates a state where the pin-type heat sink 10 is attached to the rear surface side of the liquid crystal display module 2. FIG. 3(b) is a plan view of the pin-type heat sink 10. FIG. 3(c) is a side view of the pin-type heat sink 10.

A heat sink is a component that can be attached to machinery and electric components (heating elements) that generate heat. The purpose of a heat sink is to decrease the temperature of a heating element by heat dispersion. A heat sink is a type of heat-transfer device that causes heat-transfer by being in contact with the heating element. Heat sinks are also referred to as radiators or heat slingers. Heat sinks are manufactured with a metal material such as aluminum (Al) or copper (Cu) that conducts heat easily. Heat sinks vary in size and shape depending on usage. Small heat sinks are measured in millimeters, whereas large heat sinks are measured in meters.

As illustrated in FIGS. 3(b) and 3(c), the pin-type heat sink 10 has a plate-shaped base portion 11 and a plurality of pin portions 12 that rise from an outer surface of the base portion 11. The base portion 11 and the pin portions 12 are integrally molded and formed of a solid Al member. The base portion 11 is a square-shaped plate. The plate is measured 30 mm in both the height L2 and the width W2. The thickness of the base portion 11 is 3 mm. The pin portion 12 has a slender cylindrical shape. The height P of a cylinder of the pin portion 12 is 7 mm. The height H2 is 10 mm and is measured from the other outer surface, that is, a rear surface of the base portion 11 to an apex portion of the pin portion 12. The diameter of the pin portion 12 is 1.4 mm. The pitch between pin portions 12 is 3.0 mm. There are one hundred pin portions 12 on the base portion 11. The weight of the pin-type heat sink 10 is 10.5 g.

If the heating element comes into contact with the rear surface of the base portion 11 of the pin-type heat sink 10, the heat of the heating element is transferred to the plurality of pin portions 12 through the base portion 11 by the excellent heat conductivity characteristic of Al. Heat exchange is carried out between the outer surface of the pin portions 12 and air. The heat transferred to the pin portion 12 is radiated from the outer surface of the pin portion 12 to low-temperature air that is sequentially supplied to the outer surface of the pin portion 12 by convection.

The rear surface of the base portion 11 of the pin-type heat sink 10 is attached as close as possible to the outer surface of the chassis 5 that is the heating element. As illustrated in FIG. 3(a), five pin-type heat sinks 10 are arranged in line along the lower surface of the chassis 5. A left end side of the pin-type heat sink 10 at the leftmost side is inwardly positioned in the chassis 5 from the left end side of the chassis 5 by a distance D1. A lower end side of the pin-type heat sink 10 at the leftmost side is inwardly positioned in the chassis 5 from the lower end side of the chassis 5 by a distance D2. Both the distances D1 and D2 are 5 mm. The lower end sides of the remaining four pin-type heat sinks 10 are inwardly and respectively positioned in the chassis 5 from the lower end side of the chassis 5 by the distance D2. The adjacent pin-type heat sinks 10 are separated by the distance D1. Since the length of the lower end side of the chassis 5 is 180 mm as described above, five pin-type heat sinks 10 are arranged at regular intervals along the lower end side of the chassis 5. Accordingly, arrangement positions of five pin-type heat sinks 10 are positioned so as to substantially cover the positions (2), (4) and (6) on the lower side surface of the chassis 5.

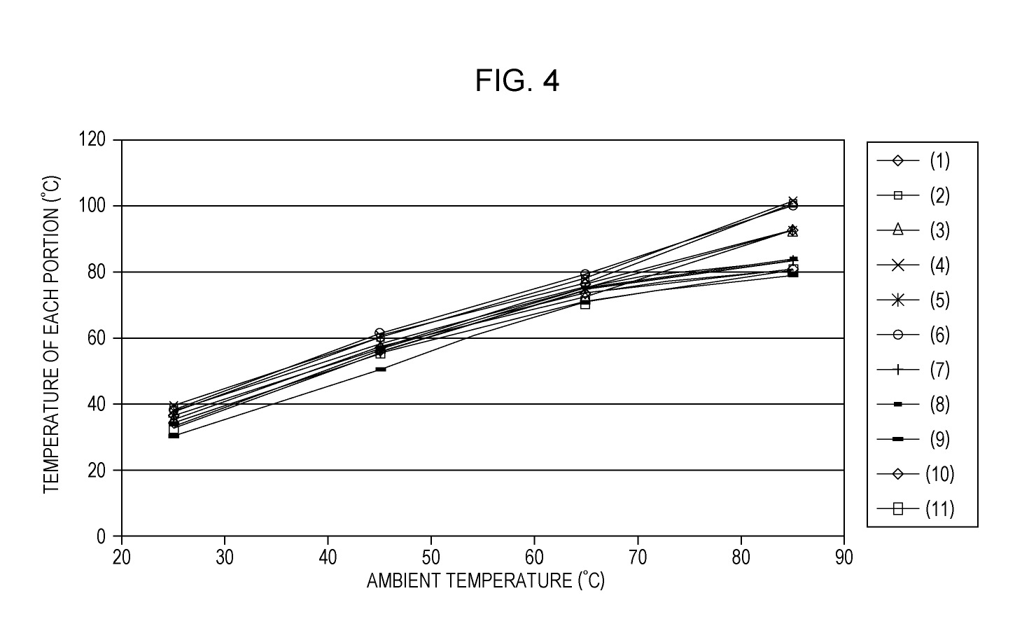

As illustrated in FIG. 3(a), FIG. 4 illustrates a result of the temperature distribution measurement of the liquid crystal display module 2 in which each temperature of the positions (1) to (11) is measured and plotted by driving the liquid crystal display module 2 to which the pin-type heat sink 10 is attached in the environment where the ambient temperature is changed in the range from 25° C. to 85° C. The horizontal axis in FIG. 4 shows the ambient temperature (° C.) of the liquid crystal display module 2, and the vertical axis shows the temperature (° C.) of each portion of the liquid crystal display module 2. Each temperature at the positions (1) to (11) is illustrated in data lines that respectively correspond to the illustrated symbols in explanatory notes at the right side of the view. Data illustrated in FIG. 4 shows that the temperatures in regions at the positions (2), (4) and (6) are decreased by approximately 10° in contrast to the data illustrated in FIG. 2 when the ambient temperature is in a range from 25° C. to 65° C., and the data shows that there is an excellent effect of radiating heat due to the pin-type heat sink 10.

However, in a high-temperature environment in which the ambient temperature is 85° C., all the temperatures at the positions (2), (4) and (6) exceed 100° C. This is an indication that the heat radiating function of the pin-type heat sink 10 is in a saturated state in the high-temperature environment of 85° C. resulting in an insufficient effect of radiating heat compared to a low-temperature environment, thereby causing the temperature around the super bright LED backlight 8 of the chassis 5 on the rear surface side of the liquid crystal display module 2 to exceed 100° C. Therefore, there is a possibility of the temperature of the light-guiding panel or the resin component that constitute the backlight exceeding the guaranteed temperature, and there is a need to take further sufficient countermeasures in order to secure the reliability of the liquid crystal display module 2.

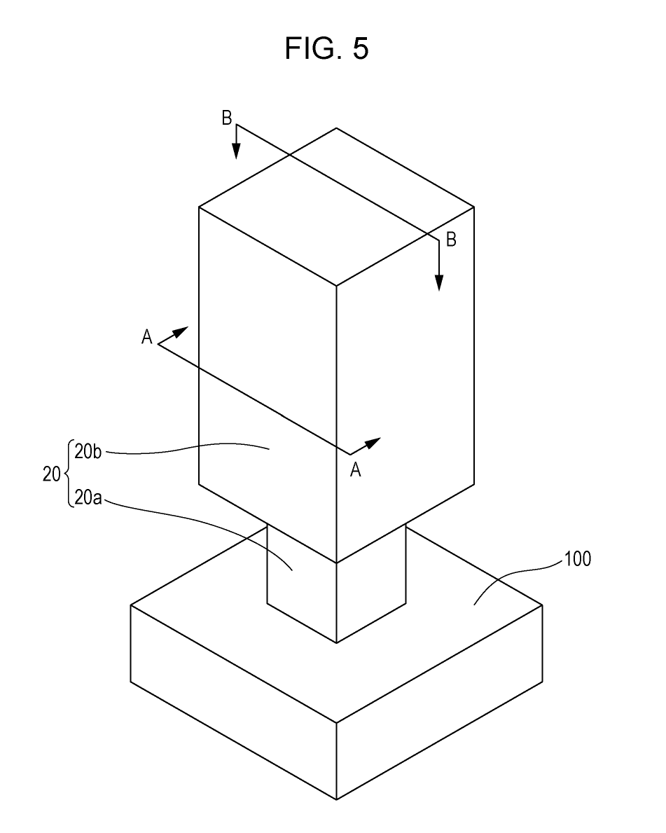

FIG. 5 is a perspective view illustrating an outer shape of a portion of the heat-transfer device according to an Example 1 in the embodiment. The heat-transfer device in its entirety according to the example has a plate-shaped base portion (not illustrated) and a plurality of pin portions 20 that rise from an outer surface of the base portion, as similar to the pin-type heat sink 10 illustrated in FIG. 3. FIG. 5 illustrates only one pin portion 20. The pin portion 20 is divided into a heating element contact portion 20a and a radiation portion 20b that is connected to the heating element contact portion 20a. The heating element contact portion 20a has a contact surface that comes into contact with the heating element 100. The radiation portion 20b is connected to the heating element contact portion 20a at a surface that is on the side opposite to the contact surface.

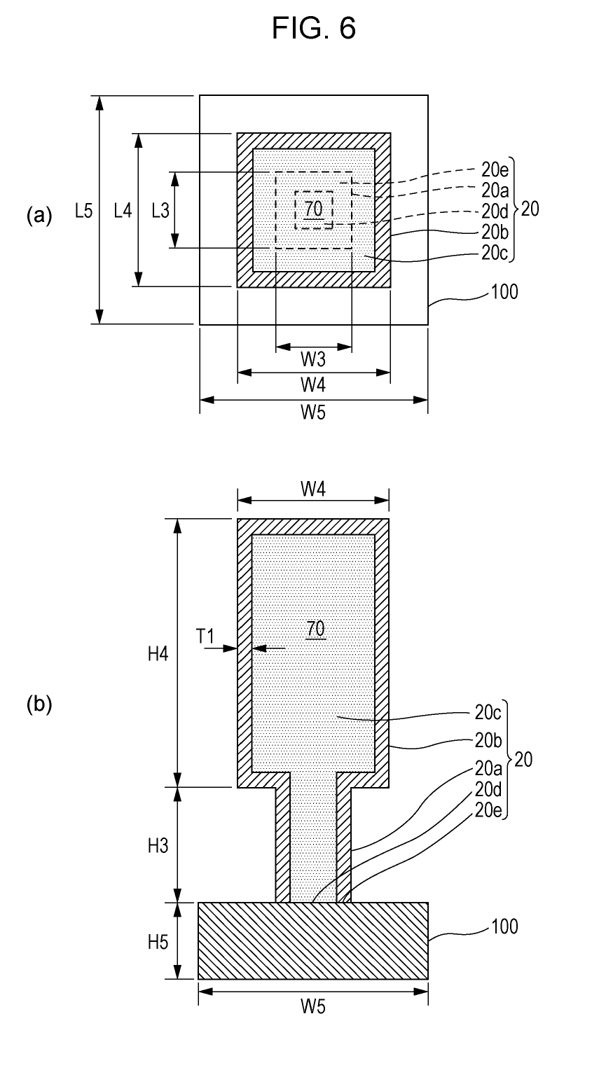

FIG. 6 illustrates a cross section of the pin portion 20 of the heat-transfer device according to the example. FIG. 6(a) illustrates a state where the cross section of which the pin portion 20 obtained by cutting the pin portion 20 in an illustrated horizontal direction (arrow direction of A-A line) taken along the line A-A in FIG. 5 viewed in a direction toward the heating element 100. FIG. 6(b) illustrates a cross section of the pin portion 20 obtained by cutting the pin portion 20 in an illustrated vertical direction (arrow direction of B-B line) taken along the line B-B in FIG. 5. As illustrated in FIGS. 6(a) and 6(b), the heating element contact portion 20a has a hollow rectangular parallelepiped shape of which both the ends are open. Opening portions at both of the ends have a square shape. A square frame-shaped contact surface 20e that comes into direct contact with the heating element 100 is formed around one opening portion 20d of the heating element contact portion 20a. The other opening portion of the heating element contact portion 20a is connected to the radiation portion 20b.

The radiation portion 20b has a hollow rectangular parallelepiped shape that has a larger volume than that of the heating element contact portion 20a. An opening that matches the other opening portion of the heating element contact portion 20a is provided in a connecting portion between the radiation portion 20b and the heating element contact portion 20a. The radiation portion 20b has a center axis that matches a center axis connecting the centers of both the opening portions of the heating element contact portion 20a. A cross section of the radiation portion 20b which is orthogonal to the center axis has a square shape. The heating element contact portion 20a and the radiation portion 20b are manufactured with aluminum (for example, Al5052). The pin portion 20 comes into contact with the heating element 100 at the contact surface 20e, and is configured to have a heat-transfer member that transfers the heat of the heating element 100 to the radiation portion 20b through the heating element contact portion 20a.

As illustrated in FIGS. 6(a) and 6(b), both the height L3 and the width W3 of the squared outer shape of the heating element contact portion 20a are 2 mm. Both the height L4 and the width W4 of the squared outer shape of the radiation portion 20b are 4 mm. A wall thickness T1 of the heating element contact portion 20a and the radiation portion 20b is 0.5 mm. The height H3 of the heating element contact portion 20a is 3 mm. The height H4 of the radiation portion 20b is 7 mm. Therefore, the height of the pin portion 20 is 10 mm. The thickness H5 of the heating element 100 is 2 mm. In order to perform a heat conduction analysis simulation described below, both the height L5 and the width W5 of the heating element 100 are set to 6 mm.

In the heating element contact portion 20a and the radiation portion 20b, a cavity portion 20c that is formed so as to extend through between the heating element contact portion 20a and the radiation portion 20b is provided. The opening of the opening portion 20d surrounded by the contact surface 20e is connected to the cavity portion 20c. The inside of the cavity portion 20c has a larger cross-sectional area than the opening portion 20d. In addition, the cross-sectional area inside the cavity portion 20c in the horizontal direction may be set so as to be more increased with increasing distance from the opening portion 20d.

The cavity portion 20c is filled with a gelled latent heat storage material 70. At least a portion of the latent heat storage material 70 comes into contact with an inner wall of the cavity portion 20c. In addition, the latent heat storage material 70 is arranged so as to be in direct contact with the heating element 100 at the opening region of the opening portion 20d that is surrounded by the contact surface 20e. For example, an outer surface of the latent heat storage material 70 at the opening region of the opening portion 20d is a flat surface that matches the contact surface 20e.

A technology of temporary heat-storage and heat-extraction in accordance with necessity is referred to as “heat storage”. Regarding the technology of heat storage, many heat-storage methods that vary depending on types of materials and types of physical or chemical phenomena have been studied and put into practical use. Examples of the heat storage methods include sensible heat storage, latent heat storage, chemical heat storage and the like. However, in the embodiment, latent heat storage is used. Latent heat storage uses latent heat of a substance to store heat energy resulting from a phase change or transition of the substance. Latent heat storage realizes high heat storage density and constant output temperature. Ice (water), paraffin, inorganic salts and the like are employed as latent heat storage materials.

The latent heat storage material 70 of the embodiment includes the paraffin. The paraffin is a translucent or white soft solid (waxy) at room temperature, is water insoluble, and is a chemically stabilized substance. In general, it is simply referred to as paraffin in Japan in many cases. However, it is particularly referred to as a paraffin wax as well to avoid confusion with kerosene (lamp oil). As the paraffin used for the latent heat storage material 70, a single or a mixture of the normal (linear chain type structure) paraffin (general formula of CₙH₂ₙ₊₂) of which the carbon number n is 14 or more is employed.

Furthermore, the latent heat storage material 70 includes a gelling agent for gelling (solidifying) the paraffin. The gelling denotes that molecules are crosslinked to form a three dimensional network structure, and a solvent is absorbed therein to be swelled. As an example of a gel, agar and gelatin can be exemplified. The latter substance is crosslinked through covalent bond by a chemical reaction and is insoluble unless the structure is destroyed, thereby being chemically stable. A super absorbent polymer of a disposable diaper, a soft contact lens or the like is a chemical gel. A gelling agent causes an effect of gelling by being simply contained several % by weight in the paraffin.

In a dispersion solution obtained by dispersing a heat storage material into the solvent, the dispersion characteristic of the heat storage material changes depending on the time course or the installation environment. For example, if the heat storage material is accumulated directly below in the dispersion solution, the heat storage characteristic of the inside of the dispersion solution in the vertical direction changes. In addition, if the rectangular parallelepiped container having different aspect ratio is filled with the dispersion solution therein, the dispersion characteristic is changed depending on placement of the rectangular parallelepiped container such as vertical placement and horizontal placement. In contrast, in the gelled heat storage material obtained by filling the heat storage material into the gelling agent, even though the heat storage material is in a phase change temperature region, the heat storage material is not liquefied and maintains the gelled state. Therefore, there is no change in the dispersion characteristic of the heat storage material.

In addition, it is difficult to fill the heat storage material without a gap into an arbitrary space that is sealed such that a space portion is generated in the sealed space. Accordingly, in contrast to a case of the liquefied heat storage material where a shape of the space portion changes depending on the placement, the space portion rarely changes in the gelled heat storage material. Therefore, it is possible to obtain the heat storage characteristic that is independent from the placement.

The gelling agent employed in the example includes a polymer material. In addition, polyethylene is employed as the polymer material. In other words, the latent heat storage material 70 of the embodiment is the paraffin containing the polyethylene that is gelled by the polyethylene. The paraffin of which the carbon number n is 20 is employed in the embodiment. Fusion point of the paraffin differs depending on the carbon number. A fusion point of the paraffin of the embodiment is approximately 38° C. Boiling point of the paraffin exceeds 300° C. In addition, a fusion point of the polyethylene is 130° C. In addition, it is possible to change viscosity of the latent heat storage material 70 by adjusting a mixing ratio of the polyethylene.

The paraffin containing the polyethylene maintains a solid state in its entirety, even though the paraffin is phase-transformed between the solid phase and the liquid phase. Therefore, the latent heat storage material 70 is enabled to maintain its entirety in the solid state before and after the phase transformation, thereby being handled easily.

In addition, the gelled paraffin generates no convection in the liquid phase. The heat from the heating element 100 is stored in the paraffin only by the heat conduction. Therefore, since no change occurs in efficiency of the heat storage by influence of gravity, it is possible to increase a degree of freedom in arrangement of the latent heat storage material 70 with respect to the heating element 100. A gap portion may be secured in the cavity portion 20c to absorb expansion and contraction of the heat storage material in volume in accordance with the phase change of the latent heat storage material 70.

In general, the latent heat storage material stores the latent heat as the heat energy which is communicated with the outside when the substance is in the phase change (phase transformation). For example, in the heat storage using the phase change between the solid and liquid, heat of fusion at a fusion point of the latent heat storage material is used. As long as two phases of the solid and the liquid are mixedly present during the phase change, the heat is continuously drawn from the outside under the constant phase change temperature such that the temperature rise up to a fusion point or above can be suppressed for a comparatively long period. Therefore, the latent heat storage further excels in consideration of the heat storage density and holding the constant temperature compared to the sensible heat storage using specific heat of the substance.

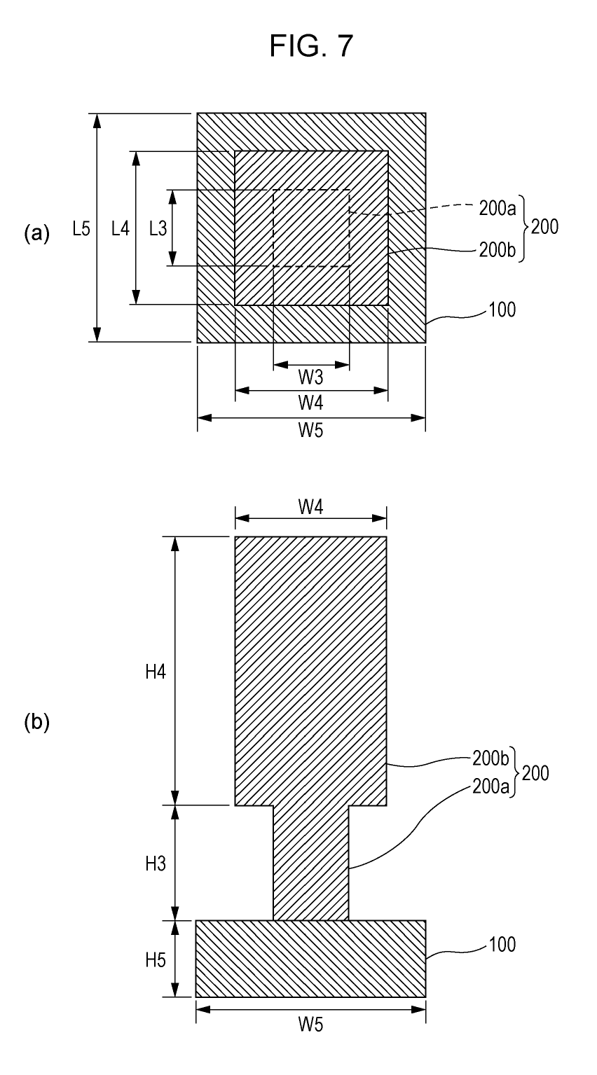

FIG. 7 illustrates a cross section of a pin portion according to a comparative example. A pin portion 200 illustrated in FIG. 7 has the same outer shape and measurement as the pin portion 20 illustrated in FIG. 5. The pin portion 200 includes a heating element contact portion 200a that has the same outer shape and measurement as the heating element contact portion 20a, and a radiation portion 200b that has the same outer shape and measurement as the radiation portion 20b. Differences between the pin portion 200 and the pin portion 20 are that the cavity portion is not present in the pin portion 200, and the heating element contact portion 200a and the radiation portion 200b are manufactured from solid Al. In other words, there is no latent heat storage material in the pin portion 200.

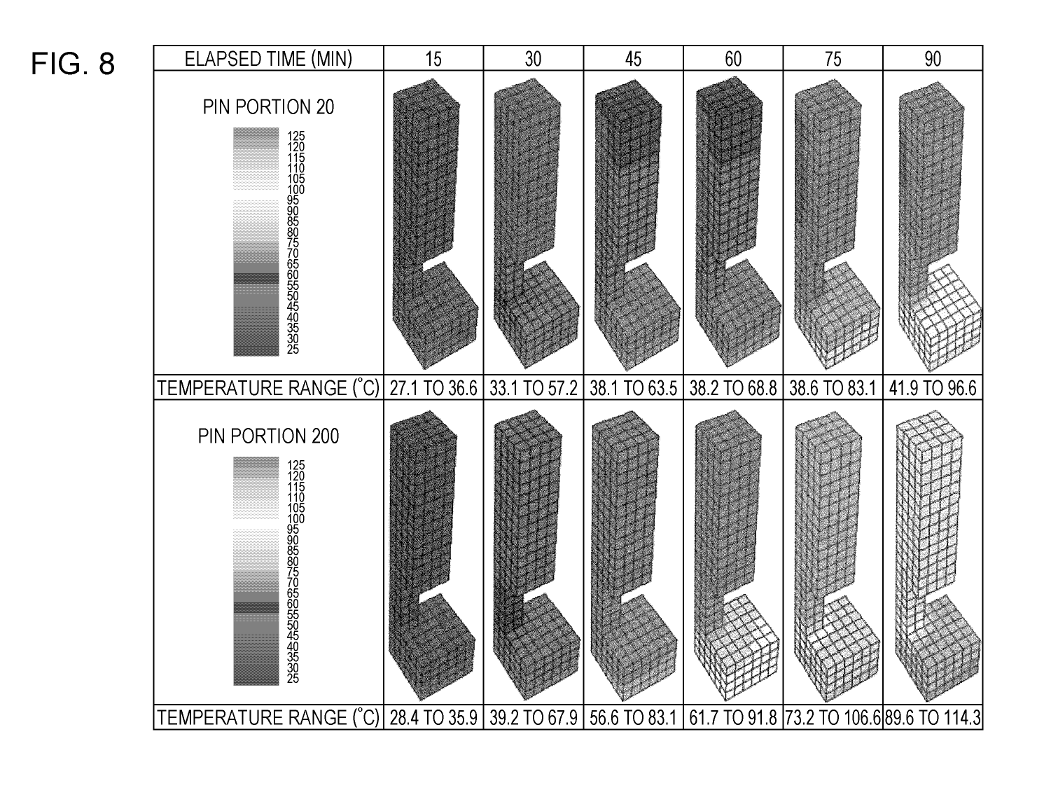

FIG. 8 illustrates a result of a heat conduction analysis simulation for describing a difference in heat conductivity characteristic between the pin portion 20 according to the example and the pin portion 200 according to the comparative example. The upper section in FIG. 8 illustrates the simulation result that is carried out regarding the pin portion 20. The lower section in FIG. 8 illustrates the simulation result that is carried out regarding the pin portion 200.

In the simulation, a simplified model that is obtained by dividing the pin portion 20 and the pin portion 200 into four equal portions in the vertical direction to be scaled down to ¼ in order to shorten calculation time in a processor.

As calculation conditions, outside air temperature is 25° C., heat-transfer coefficient of the outside air is 10 W/(m²·K), material property of the heating element 100 is SUS304, heating value of the heating element 100 is 1.5×10⁸ (W/m³), latent heat storage material is paraffin (rational formula: CH₃(CH₂)₁₈CH₃), and material property of the pin portion and the heat sink in its entirety is AL5052.

The uppermost row in FIG. 8 illustrates elapsed times after the heating element 100 starts heat generation. The explanatory notes of the temperature distribution that are respectively illustrated in the upper and lower rows at left side in FIG. 8 divide a range from 25° C. to 125° C. into 21 stages by every 5° C. in a gray scale. The lower row of the upper section in FIG. 8 illustrates a temperature range of the heating element 100 and the pin portion 20 in every elapsed time. The center of the upper section in FIG. 8 shows the temperature of the pin 20 and the heating element 100 of the simplified model in the gray scale by every element. The lower row of the lower section in FIG. 8 illustrates the range of the temperature of the heating element 100 and the pin portion 200 by every elapsed time. The center of the lower section in FIG. 8 shows the temperature of the pin 200 and the heating element 100 in the gray scale by every element.

As illustrated in the upper section in FIG. 8, in a case where the pin portion 20 according to the example is employed, the temperature distribution of the pin 20 and the heating element 100 after 15 minutes elapsed from the start of the heat generation of the heating element 100 is from 27.1° C. to 36.6° C., 33.1° C. to 57.2° C. after 30 minutes elapsed, 38.1° C. to 63.5° C. after 45 minutes elapsed, 38.2° C. to 68.8° C. after 60 minutes elapsed, 38.6° C. to 83.1° C. after 75 minutes elapsed, and 41.9° C. to 96.6° C. after 90 minutes elapsed.

Meanwhile, as illustrated in the lower section in FIG. 8, in a case where the pin portion 200 according to the comparative example is employed, the temperature distribution of the pin 200 and the heating element 100 after 15 minutes elapsed from the start of the heat generation of the heating element 100 is from 28.4° C. to 35.9° C., 39.2° C. to 67.9° C. after 30 minutes elapsed, 56.6° C. to 83.1° C. after 45 minutes elapsed, 61.7° C. to 91.8° C. after 60 minutes elapsed, 73.2° C. to 106.6° C. after 75 minutes elapsed, and 89.6° C. to 114.3° C. after 90 minutes elapsed.

As illustrated in FIG. 8, in a case where the pin portion 200 in the related art is employed, the maximum temperature of the heating element 100 exceeds 100° C. when 75 minutes elapsed after the start of the heat generation of the heating element 100. In contrast, in a case where the pin portion 20 according to the example is employed under the same conditions, a portion of the latent heat storage material 70 maintains a fusion point around 38° C., and the maximum temperature of the heating element 100 is suppressed at approximately 80° C.

According to the pin portion 20 of the example, in the elapsed time range substantially between 45 minutes to 75 minutes after the start of heat generation of the heating element 100, it is possible to greatly suppress the temperature rise of the heating element 100 by heat storage action of the latent heat storage material compared to the pin portion 200 in the related art.

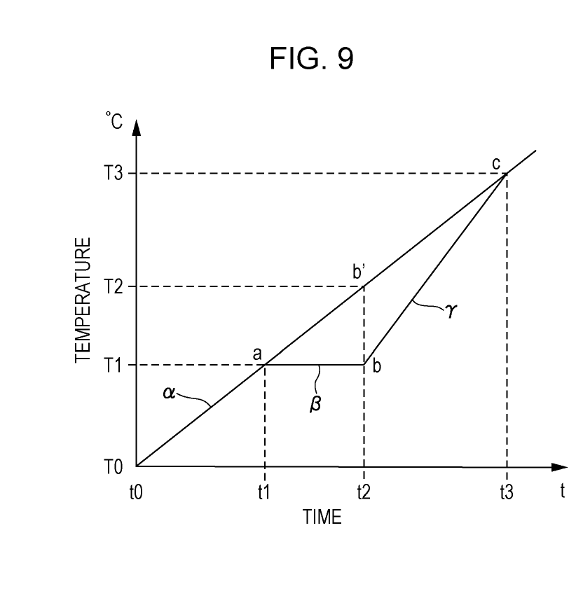

FIG. 9 illustrates an effect of employing the pin portion 20 according to the example in comparison with the pin portion 200 in the related art. The horizontal axis shows time and the vertical axis shows the temperature of the pin portion. In the illustrated drawing, a straight line α passing through a position a (time t1 and temperature T1), a position b (time t2 and temperature T2) and a position c (time t3 and temperature T3) shows the temperature rise of the pin portion 200 when the pin portion 200 in the related art is brought into contact with the heating element 100. In contrast, the pin portion 20 according to the example rises in temperature along the straight line α in a range between times t0 and t1, and in a range after time t3. However, in a range between the times t1 to t3, the pin portion 20 maintains lower temperature than that of the pin portion 200 in the related art.

The contact surface 20e of the pin portion 20 and the latent heat storage material 70 that is exposed through the opening portion 20d are in contact with the heating element 100. The pin portion 20 and the latent heat storage material 70 are set as the temperature T0 at the time t0. Since heat resistance of the heat sink itself including the pin portion 20 is extremely smaller compared to the heat resistance of an interface that comes into contact with an outer layer which is air, the heat conductivity of the heat sink itself can be approximated as being independent from quantity of the material for manufacturing the heat sink. Therefore, the temperature of the pin portion 20 rises along the straight line α as time elapses, likewise the pin portion 200. Next, if the latent heat storage material 70 reaches the phase change temperature T1 at the time t1, the temperature of the pin portion 20 and the latent heat storage material 70 maintains the temperature T1 such that the latent heat storage is carried out in the latent heat storage material 70 along a straight line β having an incline of zero up to the position b (time t2 and temperature T1). Thereafter, the temperature of the pin portion 20 and the latent heat storage material 70 rises from the temperature T1 at the time t2 to the temperature T3 at the time t3 along a straight line γ.

In this way, according to the pin portion 20 that is filled with the latent heat storage material 70, in a range between the times t1 to time t3, the temperature rise can be suppressed compared to a case where the pin portion 200 in the related art is employed. Therefore, in the phase change temperature region of the latent heat storage material 70, the latent heat storage material 70 draws the heat of the heating element 100 and works as a temporal buffer of the heat, thereby enabling the heating element 100 to be retarded in temperature rise. According to the heat sink provided with the pin portion 20 of the example, it is possible to greatly improve efficiency of the heat-transfer for transferring the heat of the heating element 100 by having the outer shape and the measurement thereof is set similar to the heat sink in the related art.

In this way, the heat sink (heat-transfer device) according to the embodiment is provided with the contact surface 20e coming into contact with the heating element 100. The heat sink includes the pin portion (heat-transfer member) 20 that transfers the heat of the heating element 100 through the contact surface 20e, and the gelled latent heat storage material 70 that is arranged to be in contact with the pin portion 20 and is capable to be in contact with the heating element 100.

According to the above configuration, it is possible to radiate the heat of the heating element 100 from the pin portion 20 through the contact surface 20e. Furthermore, it is possible to temporarily store the heat of the heating element 100 by the latent heat storage material 70. In other words, it is possible not only to radiate the heat of the heating element 100 but also to store the heat that is temporarily increased in the heating element 100 into the latent heat storage material 70. Accordingly, it is possible to smooth thermal fluctuation of the heating element 100, and suppress temperature fluctuation of the heating element 100.

In addition, according to the above configuration, since the gelled latent heat storage material 70 is employed, the efficiency of the heat radiation and storage unlikely receives influence of gravity compared to a heat storage material of liquid state. In addition, there is no heat-transfer by convection in the gelled latent heat storage material 70. Therefore, it is possible to increase the degree of freedom in an arrangement aspect of the heat sink with respect to the heating element 100.

In general, the heat-transfer is carried out in the heat sink using natural convection of air. However, in the heat sink according to the embodiment, even though the number of the radiation fins is not increased, the temperature rise of the heating element can be suppressed such that reduction in size of the device can be realized. In addition, in a case where the heat of the radiation fins is forcibly cooled by a cooling fan, in the heat sink according to the embodiment, the degree of freedom in the arrangement aspect is high and the reduction in size is possible such that a sufficient installation space for the cooling fan can be secured. In addition, since the output of the cooling fan can be reduced, there is no need for noise control and it is possible to control an increase in electricity consumption.

In addition, the latent heat storage material 70 according to the embodiment includes the gelling agent. Since the latent heat storage material 70 can be solidified by the gelling agent, the heat-transfer device is easily handled and can be preferably employed in cooling the heating element that is built in ordinary appliances.

In addition, the gelling agent of the latent heat storage material 70 according to the embodiment includes a polymer material. Polymer materials are inexpensive and easy to obtain generally. In addition, the polymer material has a fusion point that is higher than a fusion point of the paraffin as a heat storage material and far lower than the boiling point of the paraffin, thereby being preferable as the gelling agent.

In addition, the latent heat storage material 70 according to the embodiment includes the paraffin. Since a fusion point of the paraffin can be changed by adjusting the carbon number, the latent heat storage material provided with a desired heat storage characteristic has an advantage to be easily manufactured. For example, n-tetradecane (molecular formula: C₁₄H₃₀) has a fusion point of 5.9° C. and fusion calories of 229.8 kJ/kg, n-pentadecane (molecular formula: C₁₅H₃₂) has a fusion point of 9.9° C. and fusion calories of 163.8 kJ/kg, n-hexadecane (molecular formula: C₁₆H₃₄) has a fusion point of 18.2° C. and fusion calories of 228.8 kJ/kg, n-heptadecane (molecular formula: C₁₇H₃₆) has a fusion point of 22.0° C. and fusion calories of 168.4 kJ/kg, n-octadecane (molecular formula: C₁₈H₃₈) has a fusion point of 28.2° C. and fusion calories of 234.6 kJ/kg, n-nonadecane (molecular formula: C₁₉H₄₀) has a fusion point of 32.1° C. and fusion calories of 170.6 kJ/kg, and n-icosane (molecular formula: C₂₀H₄₂) has a fusion point of 36.8° C. and fusion calories of 237.3 kJ/kg.

In addition, the latent heat storage material 70 according to the embodiment may include a hydrated salt based heat storage material. In general, the hydrated salt based heat storage material is inexpensive and has high heat conductivity compared to an organic based heat storage material. For example, in contrast to a case where the heat conductivity of the paraffin based heat storage material is around 0.35 W/(m·K), magnesium chloride (molecular formula: MgCl.6H₂O) is 2.1 W/(m·K) and strontium hydroxide (molecular formula: Sr(OH)₂.8H₂O) is 1.8 W/(m·K), thereby being extremely high in heat conductivity.

In addition, the pin portion 20 according to the embodiment is provided with the cavity portion 20c therein. The material property of the pin portion 20 is extremely high in heat conductivity such as Al, Cu or the like. Therefore, even if the inside of the pin portion 20 is a cavity, the radiation characteristic shows little difference compared to a case where the pin portion 20 is solid metal. The materials for manufacturing the pin portion 20 can be reduced by providing the cavity portion 20c.

In addition, the latent heat storage material 70 according to the embodiment is filled in the cavity portion 20c. It is possible to attempt a reduction in size of the heat-transfer member by filling the latent heat storage material 70 in the cavity portion 20c of the pin portion 20 compared to a case where the latent heat storage material 70 is in contact with an outer wall of the pin portion 20. In addition, since the inner surface of the cavity portion 20c and the outer surface of the latent heat storage material 70 can be brought into contact with each other extensively, the heat of the latent heat storage material 70 can be efficiently radiated from the pin portion 20.

In addition, the pin portion 20 according to the embodiment is provided with the opening portion 20d that is connected to the cavity portion 20c. Accordingly, the cavity portion 20c can be easily filled with the latent heat storage material 70 therein through the opening portion 20d. In addition, since the latent heat storage material 70 is gelled so as not to leak from the opening portion 20d, there is no need for blocking the opening portion 20d. In other words, there is no need for sealing the opening portion 20d. From a point of view of filling the latent heat storage material 70 into the cavity portion 20c, the opening portion can be in an arbitrary position to be open in the pin portion 20.

In addition, in the pin portion 20 according to the embodiment, the latent heat storage material 70 is enabled to be in direct contact with the heating element 100 in the opening portion 20d. Since the latent heat storage material 70 in the embodiment is maintained in the solid state regardless of the phase transformation state, the latent heat storage material 70 maintains the own shape, even if the latent heat storage material 70 is exposed through the opening portion 20d. Accordingly, the latent heat storage material 70 can be in direct contact with the heating element 100, thereby being able to efficiently absorb the heat compared to a case of receiving the heat of the heating element 100 through the wall portion of the pin portion 20.

The heat stored in the latent heat storage material 70 can be not only transferred to the heating element contact portion 20a and the radiation portion 20b, but also transferred to the heating element 100 when the temperature of the heating element 100 is dropped. Therefore, the heat-transfer device according to the embodiment can contribute to constancy and planarization in the temperature of the heating element 100.

If the latent heat storage material employed in the related art is fused, the latent heat storage material is liquefied. In addition, there is a latent heat storage material into which a liquefied substance is mixed. The aforementioned heat storage materials have to be sealed in the heat sink such that the heat storage material can receive the heat of the heating element only through the wall of the heat sink. In other words, in a configuration of the related art, the heat cannot be stored by bringing the heat storage material into direct contact with the heating element. In contrast, according to the configuration of the embodiment, the latent heat storage material 70 comes into direct contact with the heating element 100 at the opening portion 20d, thereby enabling the heat of the heating element 100 to be efficiently stored.

In addition, in the pin portion 20 of the embodiment, the contact surface 20e is formed around the opening portion 20d. Accordingly, the heat of the heating element 100 can be directly transferred from the contact surface 20e to the wall surface of the pin portion 20 to be radiated. At the same time, the heat of the heating element 100 can be efficiently absorbed to the latent heat storage material 70.

In addition, the cavity portion 20c according to the embodiment has a larger cross-sectional area than that of the opening portion 20d. The cross-sectional area of the cavity portion 20c of the radiation portion 20b in the horizontal direction is (W4−2·T1)×(L4−2·T1)=(4−2×0.5)×(4−2×0.5)=9 mm². The cross-sectional area of the opening portion 20d is (W3−2·T1)×(L3−2·T1)=(2−2×0.5)×(2−2×0.5)=1 mm². In this shape, it is possible to acquire radiation area by increasing the outer surface area of the radiation portion 20b as much as possible. In addition, volume of the latent heat storage material 70 can be increased as much as possible. The cross-sectional area of the cavity portion 20c may certainly become larger as being separated farther away from the opening portion 20d.

In the heat-transfer device according to the embodiment described in the above, even though the heating value of the heating element 100 is temporarily increased, it is possible to suppress the temperature rise of the heating element 100 by the heat storage function of the latent heat storage material 70. Therefore, in the related art, a thermal design in which a large-sized heat sink having the large maximum radiation ability is arranged needs to be performed so as to be able to temporarily cover the maximum heating value of the heating element 100. However, according to the embodiment, it is possible to employ a small-sized heat sink. Accordingly, the installation space for the heat sink is easily secured, and cost for the heat control can be reduced.

Therefore, it is preferable that the heat-transfer device according to the embodiment be used as the cooling device for a lighting apparatus such as an electronic component in which the heating value changes depending on a process volume likewise a CPU, and a backlight in which brightness is changeable in accordance with a luminance change of an image within a display region causing the heating value to be changed.

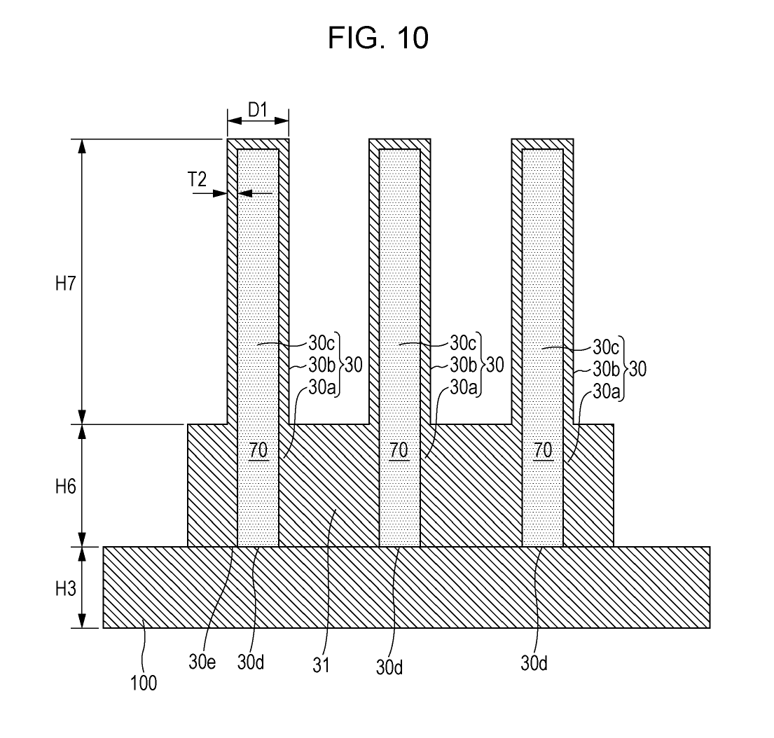

FIG. 10 is a cross-sectional view illustrating a portion of the heat-transfer device according to an Example 2 in the embodiment. As similar to the pin-type heat sink 10 illustrated in FIG. 3, the heat-transfer device in its entirety according to the example has a plate-shaped base portion 31 and a plurality of pin portions 30 that rise from an outer surface of the base portion 31. The pin portion 30 is divided into a heating element contact portion 30a and a radiation portion 30b that is connected to the heating element contact portion 30a. The heating element contact portion 30a of the pin portion 30 is integrally molded with the base portion 31. Therefore, there is no dividing line between the heating element contact portion 30a and the base portion 31. However, a region of the radiation portion 30b that is extended to the base portion 31 is referred to as the heating element contact portion 30a. The heating element contact portion 30a has a contact surface 30e that comes into contact with the heating element 100. The radiation portion 30b is connected to the contact surface 30e of the heating element contact portion 30a at a surface that is the opposite side thereof.

Three pin portions 30 that form a line are exemplified in FIG. 10. As illustrated in FIG. 10, the heating element contact portion 30a has a hollow cylindrical shape of which both the ends are open. The opening portions at the both ends are in a circle shape. A contact surface 30e that comes into direct contact with the heating element 100 is formed around one opening portion 30d of the heating element contact portion 30a. The other opening portion of the heating element contact portion 30a is connected to the radiation portion 30b.

The radiation portion 30b has the same inner diameter as the heating element contact portion 30a, and has a hollow cylindrical shape. An opening that matches the other opening portion of the heating element contact portion 30a is provided in a connecting portion between the radiation portion 30b and the heating element contact portion 30a. The radiation portion 30b has a center axis that matches a center axis connecting the centers of both the opening portions of the heating element contact portion 30a. A cross section that is orthogonal to the center axis of the radiation portion 30b is in a circle shape. The heating element contact portion 30a and the radiation portion 30b are integrally manufactured with the aluminum (for example, Al5052). The pin portion 30 comes into contact with the heating element 100 at the contact surface 30e, and is configured to have a heat-transfer member that transfers the heat of the heating element 100 to the radiation portion 30b through the heating element contact portion 30a.

The base portion 31 that includes the heating element contact portion 30a is a square-shaped flat plate. The plate is measured 30 mm in both the lengths of a height L2 and a width W2. A thickness H6 of the base portion 11 is measured 3 mm. The pin portion 30 has a slender cylindrical shape. A height H7 of a cylinder of the pin portion 30 is measured 7 mm. A height is measured 10 mm that is measured from the other outer surface, that is, a rear surface of the base portion 31 to an apex portion of the pin portion 30. The outer diameter D1 of the pin portion 30 is measured 1.4 mm. A thickness of the wall T2 of the pin portion 30 is measured 0.4 mm. A pitch between pin portions 30 is measured 3.0 mm. There are one hundred pin portions 30 on the base portion 31.

In the heating element contact portion 30a and the radiation portion 30b, a hollow cylindrical-shaped cavity portion 30c that is formed by passing through between the heating element contact portion 30a and the radiation portion 30b is provided. The opening of the opening portion 30d surrounded by the contact surface 30e is connected to the cavity portion 30c.

The cavity portion 30c is filled with the gelled latent heat storage material 70. At least a portion of the latent heat storage material 70 comes into contact with an inner wall of the cavity portion 30c. In addition, the latent heat storage material 70 comes into direct contact with the heating element 100 at an opening region of the opening portion 30d that is surrounded by the contact surface 30e.

According to the above configuration, it is possible to radiate the heat of the heating element 100 from the pin portion 30 through the contact surface 30e. Furthermore, it is possible to temporarily store the heat of the heating element 100 by the latent heat storage material 70. In other words, it is possible not only to radiate the heat of the heating element 100 but also to store the heat that is temporarily increased in the heating element 100 into the latent heat storage material 70. Accordingly, it is possible to smooth the thermal fluctuation of the heating element 100, and suppress the temperature fluctuation of the heating element 100. According to the above configuration, it is possible to have a similar outer shape as the pin-type heat sink 10 in the related art and exhibit similar effects as in the Example 1.

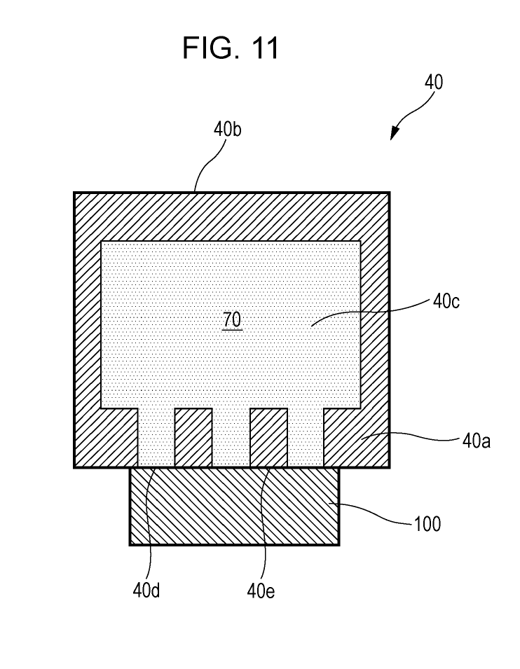

FIG. 11 is a cross-sectional view illustrating a portion of the heat-transfer device according to an Example 3 in the embodiment. The heat-transfer device in its entirety according to the example has a box type-shaped heat-transfer member 40. The heat-transfer member 40 is divided into a heating element contact portion 40a and a radiation portion 40b that is connected to the heating element contact portion 40a. The heating element contact portion 40a has a contact surface 40e that comes into contact with the heating element 100. The radiation portion 40b is connected to the contact surface 40e of the heating element contact portion 40a at a surface that is the opposite side thereof.

As illustrated in FIG. 11, the heating element contact portion 40a has a plurality of cavity portions that pass through a region including a contact surface 40e. An opening portion at both the ends of the cavity portion has a square shape, for example. A periphery of one opening portion 40d of the heating element contact portion 40a is the contact surface 40e that comes into direct contact with the heating element 100. The other opening portion of the heating element contact portion 40a faces the radiation portion 40b.

The radiation portion 40b has a cavity portion (hereinafter, both the cavity portions are referred to as cavity portions 40c) that is connected to the cavity portion of the heating element contact portion 40a. An opening that matches the other opening portion of the heating element contact portion 40a is provided in a connecting portion between the radiation portion 40b and the heating element contact portion 40a. A cross section of the radiation portion 40b that is orthogonal to the opening is in a square shape. The heating element contact portion 40a and the radiation portion 40b are integrally manufactured with the aluminum (for example, Al5052). The heat-transfer member 40 comes into contact with the heating element 100 at the contact surface 40e, and is configured to have a heat-transfer member that transfers the heat of the heating element 100 to the radiation portion 40b through the heating element contact portion 40a.

An opening of the opening portion 40d surrounded by the contact surface 40e is connected to the cavity portion 40c. The inside of the cavity portion 40c has a larger cross-sectional area than the opening portion 40d. In addition, the cross-sectional area inside the cavity portion 40c in the horizontal direction may be set to be more increased as being distanced farther away from the opening portion 40d.

The cavity portion 40c is filled with the gelled latent heat storage material 70. At least a portion of the latent heat storage material 70 comes into contact with an inner wall of the cavity portion 40c. In addition, the latent heat storage material 70 comes into direct contact with the heating element 100 at an opening region of the opening portion 40d that is surrounded by the contact surface 40e.

According to the above configuration, it is possible to radiate the heat of the heating element 100 from the heat-transfer member 40 through the contact surface 40e. Furthermore, it is possible to temporarily store the heat of the heating element 100 by the latent heat storage material 70. In other words, it is possible not only to radiate the heat of the heating element 100 but also to store the heat that is temporarily increased in the heating element 100 into the latent heat storage material 70. Accordingly, it is possible to smooth the thermal fluctuation of the heating element 100, and suppress the temperature fluctuation of the heating element 100. According to the above configuration, it is possible to exhibit similar effects as in the Examples 1 and 2.

### Second Embodiment

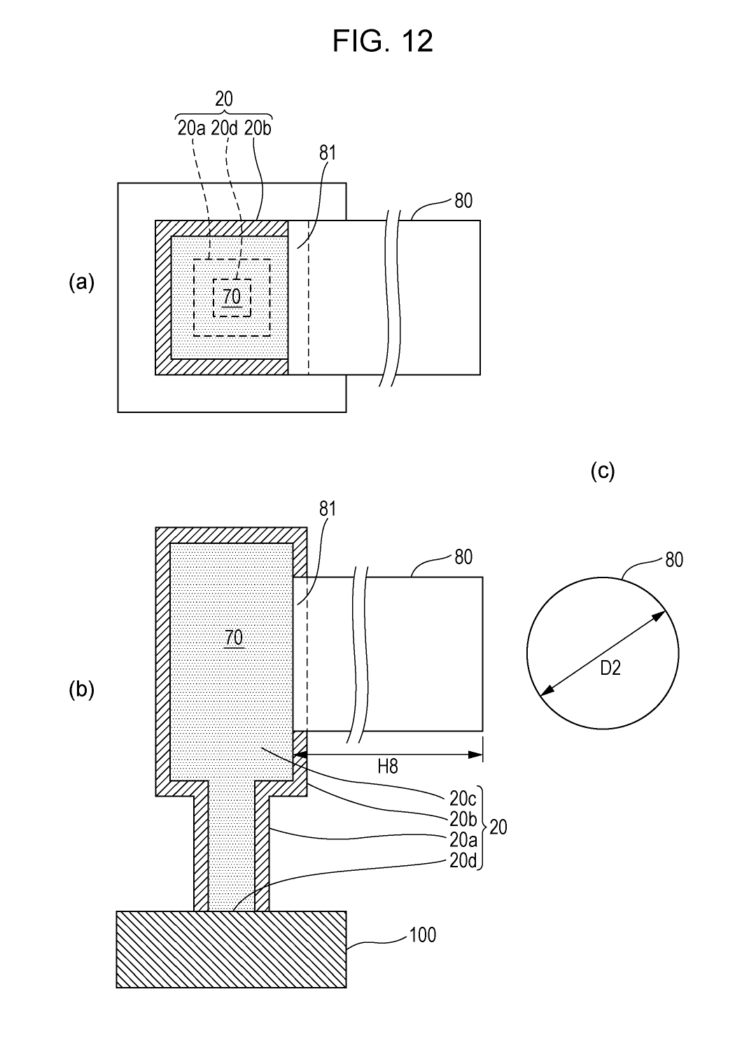

Next, the heat-transfer device according to a second embodiment of the invention will be described. FIG. 12 illustrates a portion of the heat-transfer device according to the embodiment. The heat-transfer device according to the embodiment has the pin portion 20 that is illustrated in FIG. 6 in the first embodiment, and a heat pipe 80 that is attached to the pin portion 20. The same configurations described in the first embodiment will be applied with the same reference numerals and the description thereof will not be repeated. FIG. 12(a) illustrates a cross section of the pin portion 20 that is viewed in the same direction as the FIG. 6(a), and the heat pipe 80. FIG. 12(b) illustrates a cross section of the pin portion 20 that is viewed in the same direction as the FIG. 6(b), and the heat pipe 80. FIG. 12(c) illustrates a bottom surface of the heat pipe 80.

The heat pipe 80 is attached to one rectangular parallelepiped-shaped side wall of the radiation portion 20b of the pin portion 20. The inside of the heat pipe 80 has a hollow cylindrical tubular shape. A cylindrical outer wall of the heat pipe 80 is made of copper. An outer diameter D2 of the cylindrical outer wall is 4 mm, and a height H8 is measured 50 mm.

In one side wall of the radiation portion 20b of the pin portion 20, a through hole 81 is opened into which one end portion of the cylinder of the heat pipe 80 is fit. The latent heat storage material 70 is exposed through the through hole 81. A bottom surface outer wall of the heat pipe 80 in which one end portion of the cylinder is fit in the through hole 81 comes into direct contact with the latent heat storage material 70.

Inside of a sealed hollow tube of the heat pipe 80 is filled with a smaller amount of hydraulic fluid compared to an inner volume of the tube. Water is employed as the hydraulic fluid in the embodiment. A capillary structure is arranged on an inner wall of the tube. An amount of heat transport Q of the heat pipe 80 is 20 W (MAX).

The vicinity of a bottom surface portion in contact with the latent heat storage material 70 of the heat pipe 80 is referred to as a heating portion, and the other side is referred to as a radiating portion. If the heat that is stored in the latent heat storage material 70 is transferred to the heating portion, the hydraulic fluid is vaporized. Steam absorbing the vaporized latent heat is transferred through the inside of the tube, thereby reaching the radiating portion. The steam radiates the vaporized latent heat in the radiating portion so as to be condensed. The hydraulic fluid that is condensed in the radiating portion passes through the capillary structure by capillary action so as to flow back to the heating portion. The phase change of the hydraulic fluid is carried out continuously, thereby enabling the heat to be transferred from the heating portion to the radiating portion.

An approximate value of the latent heat energy of the latent heat storage material 70 in the pin portion 20 which is illustrated in FIG. 6 according to the first embodiment is evaluated as follows. Specific heat c of the heat storage material in a phase change temperature range (38° C. to 40° C.) is set to 114, 500 J/(kg·K), density ρ of the heat storage material is set to 800 kg/m³, volume v of the heat storage material is set to 5.75×10⁻⁸ m³. The heat storage energy in a range 2° C. from 38° C. to 40° C. of a fusion point of the heat storage material is c×ρ×v×2=10.5 (J).

The heat storage energy can be extracted to the outside through the heat pipe 80. For example, the extracted heat is converted into electricity using a Seebeck element, and can be reused as a power for a radiation fan.

In this way, the pin portion 20 according to the embodiment is provided with the through hole 81 through which the latent heat storage material 70 is exposed, and has a heat conduction portion that transfers the heat outward by coming into contact with the latent heat storage material 70 at the through hole 81. Then, the heat conduction portion of the pin portion 20 is the heat pipe 80. It is certainly possible to employ other heat conduction portions in place of the heat pipe 80.

Various changes and modifications can be applied to the invention without being limited to the above embodiments.

For example, the heat-transfer device according to the above embodiments, a shape and measurements (width, height, pitch and weight) of the heat-transfer members, and a shape and the number of the pins can be subject to appropriate change. It is not necessary for the base portion to be in the square shape. The base portion may be in a rectangular shape, a polygonal shape, a circular shape and an elliptical shape. The pin does not have to be in a cylindrical shape. The pin may be in a prism shape.

The heat-transfer device according to the embodiments is not limited to the pin-type heat sink. For example, the heat-transfer device can be also applied to a corrugate-type heat sink. In addition, it is certainly possible to apply the heat-transfer member according to the embodiments to not only the radiation pin but also to a radiation fin.

In addition, a shape of measurements (width, height, angular field and weight) of the liquid crystal display device to which the heat-transfer device according to the embodiments is attached can be subject to appropriate change. Without being limited to the liquid crystal display module for mobiles that is employed in the embodiments, the heat-transfer device may be attached to a large liquid crystal television or a liquid crystal display device for small portable telephones.

In the above embodiments, a heat-transfer device that transfers the heat from a heating element is described. However, the invention is not limited thereto, thereby enabling applications to a chiller, radiator, heat exchange member, radiation member, heat absorption member and the like as well.

Particularly, it is preferable to apply the invention to, for example, a central processing unit (CPU) of which operation (generation of heat) is intermittent and, for example, a lighting apparatus for lavatories of which light is only lit when used by a person.

The heat-transfer device according to the embodiments can draw the heat that is instantaneously generated in equipment in which the heat is intermittently generated. Therefore, the heat-transfer device according to the embodiments can delay the temperature rise of the equipment by functioning as a temporal buffer for the heat. Accordingly, it is possible to improve reliability of the equipment.

Matters described in the above detailed description, particularly the matters described in the examples and modification example can be combined.

### INDUSTRIAL APPLICABILITY

The present invention can be widely used in a heat-transfer device that comes into contact with a heating element to carry out heat-transfer.

### REFERENCE SIGNS LIST

2 liquid crystal display module
3 bezel
4 liquid crystal display panel
5 chassis
6 flexible printed circuit
8 super bright LED backlight
10 pin-type heat sink
11 base portion
12, 20, 30 pin portion
20a, 30a, 40a heating element contact portion
20b, 30b, 40b heat radiation portion
20c, 30c, 40c cavity portion
20d, 30d, 40d opening portion
20e, 30e, 40e contact surface
40 heat-transfer member
70 latent heat storage material
80 heat pipe
81 through hole
100 heating element

1-14. (canceled)

15. A heat-transfer device comprising:
a heat-transfer member that is provided with a contact surface which comes into contact with a heating element and transfers heat of the heating element through the contact surface; and
a gelled latent heat storage material that is arranged so as to be in contact with the heat-transfer member and is also able to contact the heating element.

16. The heat-transfer device according to claim 15,
wherein the gelled latent heat storage material includes a gelling agent.

17. The heat-transfer device according to claim 16,
wherein the gelling agent includes a polymer material.

18. The heat-transfer device according to claim 15,
wherein the gelled latent heat storage material includes paraffin.

19. The heat-transfer device according to claim 15,
wherein the gelled latent heat storage material includes a hydrated salt based heat storage material.

20. The heat-transfer device according to claim 15,
wherein the heat-transfer member is provided with a cavity portion therein.

21. The heat-transfer device according to claim 20,
wherein the cavity portion is filled with the gelled latent heat storage material.

22. The heat-transfer device according to claim 21,
wherein the heat-transfer member is provided with an opening portion that is connected to the cavity portion.

23. The heat-transfer device according to claim 22,
wherein the gelled latent heat storage material is able to contact the heating element in the opening portion.

24. The heat-transfer device according to claim 22,
wherein the contact surface is formed around the opening portion.

25. The heat-transfer device according to claim 15,
wherein the cavity portion has a larger cross-sectional area than that of the opening portion.

26. The heat-transfer device according to claim 25,
wherein the cross-sectional area increases with increasing distance from the opening portion.

27. The heat-transfer device according to claim 15,
wherein the heat-transfer member is provided with a through hole through which the gelled latent heat storage material is exposed, and
the heat-transfer member has a heat conduction portion that transfers the heat outward by coming into contact with the gelled latent heat storage material at the through hole.

28. The heat-transfer device according to claim 27,
wherein the heat conduction portion is a heat pipe.

29. The heat-transfer device according to claim 15,
wherein the gelled latent heat storage material is arranged so as to be in direct contact with the heating element.
